(19) United States
(12) Patent Application Publication
(10) Pub. No.: US 2010/0303400 A1
(43) Pub. Date: Dec. 2, 2010

(54) APPARATUS FOR DETECTING THE LOAD ON A BEARING

(75) Inventors: Carsten Duppe, Kuernach (DE); Martin Kram, Gerolzhofen (DE)

Correspondence Address: LUCAS & MERCANTI, LLP, 475 Park Avenue South, New York, NY, 10016, US

(73) Assignee: SCHAEFFLER TECHNOLOGIES GMBH & CO. KG, Herzogenaurach (DE)

(21) Appl. No.: 12/739,183

(22) PCT Filed: Oct. 16, 2008
(86) PCT No.: PCT/DE08/01694

§ 371 Date: Apr. 22, 2010

(30) Foreign Application Priority Data
Oct. 23, 2007 (DE) 10 2007 050 576.2

(51) Int. Cl. F16C 33/58; G01L 1/24

(52) U.S. Cl. 384/622; 73/862.624

(57) ABSTRACT

An apparatus for detecting the load on a rolling bearing which has at least one bearing ring. The apparatus has a transmitter for electromagnetic radiation, and a receiver for the radiation emitted by the transmitter. A space-saving and simple apparatus for detecting the load on the bearing ring of the bearing is achieved, by virtue of the fact that an optical waveguide is provided, into which the transmitter couples the electromagnetic radiation, and by virtue of the fact that the optical waveguide is arranged on a surface of the at least one bearing ring, and by virtue of the fact that the at least one bearing ring is in the region of an evanescent field coming from the optical waveguide. Also, a rolling bearing, which has at least one bearing ring with an apparatus for detecting the load on the at least one bearing ring is disclosed.

### FIELD OF THE INVENTION

The invention relates to an apparatus as claimed in the preamble of claim 1 for detecting the load on at least one bearing, in particular a rolling bearing, having at least one bearing ring, and a bearing, in particular a rolling bearing, as claimed in claim 10.

From the practice of bearings, in particular rolling bearings, it is known that when the bearing is operating, the at least one bearing ring of the bearing is subjected to reversible deformation. If this deformation of the bearing ring is detected, for example by means of optical methods, the mechanical load occurring on the at least one bearing ring during operation of the bearing can be determined.

DE 10 2004 043 754 B3 describes an apparatus for detecting the load on a bearing ring of a bearing, specifically an external ring of a rolling bearing. The apparatus comprises a transmitter, arranged on the outside of the bearing, for electromagnetic radiation in the range of visible light, and a receiver for detecting the radiation emitted by the transmitter. A light passage, also arranged on the outside of the bearing ring, is formed between the transmitter and the receiver and is embodied in the manner of a gap, a slit or a bore. If mechanical deformations occur in the bearing ring, the shape of the light passage changes, in particular the light passage becomes narrower, with the result that the receiver detects a reduced intensity and the mechanical deformation of the bearing ring is detectable. It is disadvantageous that the light passage takes up a considerable amount of space on the outside of the bearing ring, and also that the light passage has a considerable extent in the perpendicular direction with respect to the axis of the rolling bearing. It is also unfavorable that the geometry of the light passage can also change as a result of processes other than the deformation occurring in the bearing ring, for example the light passage which is formed from plastic can age over time and taper. It is also unfavorable that only a fraction of the radiation emitted by the transmitter reaches the receiver and is blocked at the light passage, with the result that a high-power transmitter or a very sensitive receiver is necessary in order to detect a signal which can be evaluated clearly above the noise level. Factors such as temperature or humidity between the transmitter and the receiver in the surroundings of the light passage also influence the measurement result.

### OBJECT OF THE INVENTION

The object of the invention is to specify a space-saving, simple apparatus for detecting the load on the bearing ring of the bearing.

### SUMMARY OF THE INVENTION

This object is achieved according to the invention for the specified apparatus having the features of claim 1 for a bearing as claimed in claim 10.

The lightguide between the transmitter and the receiver permits the beam from the transmitter which is input into the lightguide to be conducted largely without being influenced by the surroundings. There are also no losses in terms of the intensity of the beam as a result of optical elements arranged between the transmitter and the receiver. It is therefore possible to ensure that a reduction in the light intensity detected by the receiver is due to the lightguide and not to other factors.

Total reflection occurs in the lightguide, at its external surface, with the result that optical losses can be largely avoided. During the total reflection, the beam which is in the lightguide meets, at the external surface, an optically thinner medium in which the beam penetrates in an attenuated fashion which is exponential with respect to the distance from the external surface of the lightguide. For IR radiation, the range of this evanescent field is of the order of magnitude of the wavelength of the radiation, that is to say approximately several micrometers. If the surroundings of the lightguide in the region of the evanescent field change, the intensity of the light beam which is detected by the receiver also changes, with the result that a high spatial resolution is achievable in a direction perpendicular to the axis of the bearing.

It also proves advantageous that the lightguide is made very thin and therefore takes up less space at the bearing, and also that the lightguide is inexpensive to manufacture and robust during operation.

So that the bearing ring is located in the region of the evanescent field coming from the lightguide, it may be provided that the lightguide maintains a distance from the surface of the bearing ring of the order of magnitude of the range of the evanescent field, that is to say essentially of the order of magnitude of the lightwave length of the lightguide. Alternatively, it may be provided that the lightguide rests on the surface of the bearing ring, with the result that a contact surface is formed between the lightguide and the surface of the bearing ring, in which case the absolute value of the contact surface between the lightguide and the surface of the bearing ring changes when the bearing ring is subjected to stress.

There is preferably provision that the lightguide extends, at least in certain sections, essentially parallel to an axis of the bearing. The lightguide then detects, in particular, a signal if its location on the raceway in the interior of the bearing, which corresponds to its arrangement on the bearing, is acted on, which provides the possibility of spatially resolved detection of the load on the bearing along the circumference of the bearing.

Alternatively, there is preferably provision that the lightguide extends, at least in certain sections, at a large, approximately perpendicular angle with respect to an axis of the bearing. In this context, the lightguide may extend around the bearing ring partially or multiply, with the result that a load on the bearing ring which is averaged over the circumference of the bearing ring can be detected. It is also possible to detect only low loads on the bearing ring and/or to provide an apparatus for bearing rings with wide dimensions which undergo only a small change in the external dimensions when loading occurs.

There is preferably provision that the lightguide is held in a groove which is formed in the surface of the bearing ring. The lightguide therefore does not protrude beyond the external circumference of the bearing ring.

There is preferably provision that an optical intermediate element is provided, which optical intermediate element is arranged between the surface of the bearing ring and the lightguide and is covered, at least in sections, in the evanescent field coming from the lightguide. When the optical intermediate element approaches the lightguide, part of the intensity of the beam which is input into the lightguide is decoupled into the intermediate element via the evanescent field, in particular when the intermediate element has a comparable refractive index to that of the external region of the lightguide in which the total reflection takes place. In this way, when the intermediate element participates in the change in shape of the bearing ring under load, it is possible to bring about a significant attenuation of the beam transmitted through the lightguide, which attenuation makes it possible to determine clearly the change in shape of the bearing ring. The intermediate element has the further advantage of compensating for differences in the geometric configuration both of the surface of the bearing ring and of the external surface of the lightguide. When, for example in the case of the lightguide, the evanescent field exits at a flat or flattened section and when the surface of the bearing ring is curved, the intermediate element may have a first surface of complementary curvature facing the bearing ring and a second surface of essentially planar configuration facing the lightguide. Alternatively, the lightguide may have a circular cross section in which the evanescent field exits at a section in the shape of a circular segment, and the intermediate element may have a second surface which faces the lightguide and is likewise formed with a cross section in a circular shape or the shape of a circular segment, with the result that a constant distance is set between the external surface of the lightguide and the second surface of the intermediate element. The first surface of the intermediate element facing the bearing ring may be configured in such a way that the intermediate element can easily be attached to the bearing ring.

Of course, the intermediate element and the lightguide may be combined to form one structural unit, wherein the structural unit may also comprise the transmitter and/or the receiver. The structural unit also comprises here the gap between the lightguide and the intermediate element in which the evanescent field occurs, which field is protected from external influence in the structural unit.

It is particularly preferred that a groove and an intermediate element are provided, wherein the intermediate element is held in the groove and is supported, for example, on the edges of the groove.

The transmitter is preferably a transmitter for IR radiation, wherein in the infrared range (IR) the refractive index of many IR-permeable materials is higher than in the range of visible light, with the result that even at low angles of incidence total reflection occurs at the boundary face with an optically thinner medium, accompanied by the formation of an evanescent field.

There is preferably provision that the surface is an external surface, in particular a lateral surface or end surface, of the at least one bearing ring, wherein the lightguide also can easily be inserted in bearings which are in the installation position. A groove or an intermediate element can also easily be subsequently added at a location on the bearing which is accessible from the outside. Alternatively, a bore may be provided in the body of the bearing ring, which bore has as a surface an inner lateral surface, wherein the lightguide is arranged in the bore at a short distance from the inner lateral surface and therefore in spatial proximity to the raceway at which the mechanical loading of the bearing takes place.

Further advantages and features of the invention emerge from the dependent claims and from the description of an exemplary embodiment.

The invention is described and explained in more detail below with reference to the appended drawings and on the basis of preferred exemplary embodiments.

### BRIEF DESCRIPTION OF THE DRAWINGS

FIG. 1 shows a plan view of an exemplary embodiment of an apparatus according to the invention for detecting the loading of a bearing ring of a rolling bearing according to the invention;

FIG. 1a shows the area, D′ from FIG. 1 in an enlarged illustration;

FIG. 2 shows a perspective view of a unit composed of a transmitter, a receiver and a lightguide, which unit is a component of the apparatus from FIG. 1;

FIG. 3 shows a perspective side view of the exemplary embodiment from FIG. 1; and

FIG. 4 shows a perspective side view of a further exemplary embodiment.

### DETAILED DESCRIPTION OF THE DRAWING

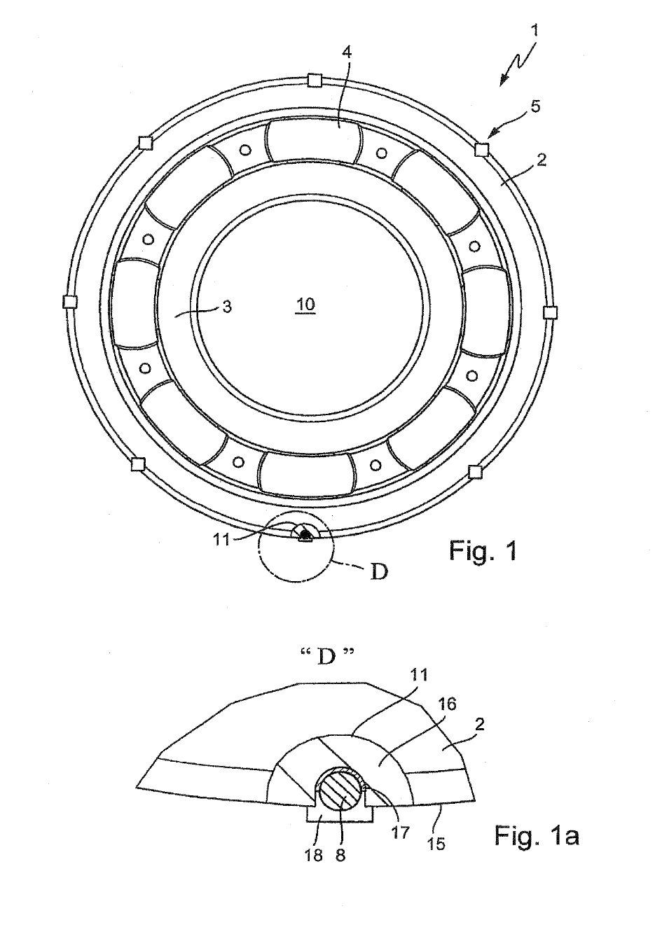

FIG. 1 shows a bearing 1, which is embodied as a rolling bearing and comprises, as bearing rings, an external ring 2 and an internal ring 3. The bearing ring 1 further comprises eight rolling bodies 4, which roll on raceways on the inside of the external ring 2 or of the internal ring 3 and in the process transmit a mechanical load to the respective bearing ring 2, 3. The eight rolling bodies 4 are held at a distance from one another by means of a rolling bearing cage, with the result that rolling bodies which are adjacent to one another enclose an angle of 45°. A shaft 10 is held in a rotationally fixed fashion in the internal ring 3, with the result that the bearing 1 supports the shaft 10 on a bearing surroundings (not illustrated). The external ring 2 is arranged fixedly with respect to the bearing surroundings.

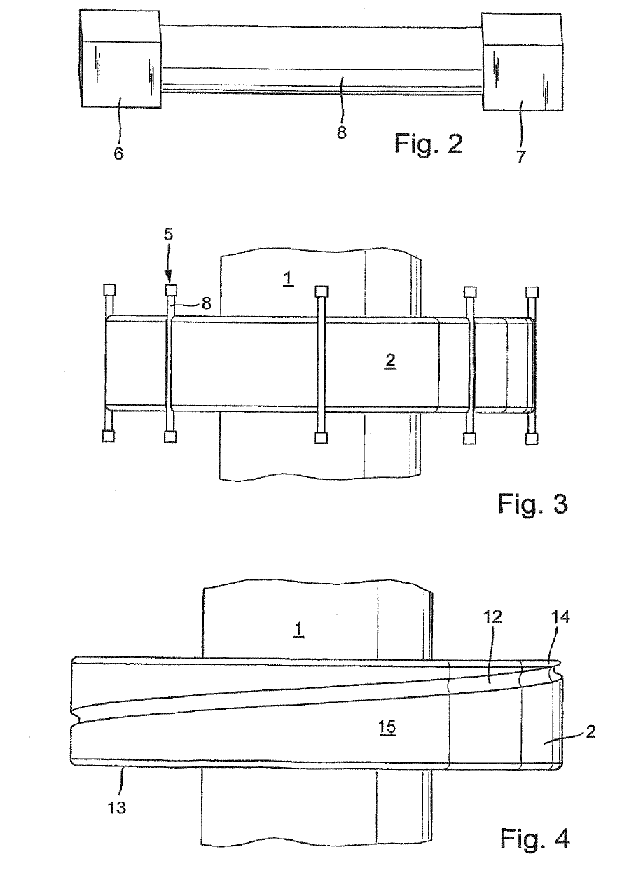

The bearing 1 comprises an apparatus 5 for detecting the load on the external ring 2, wherein the apparatus 5 has eight transmitters 6 which are each connected to eight receivers 7 by means of one lightguide 8 in each case. Each of the transmitters 6 is combined with the receiver 7 and the lightguide 8 to form a structural unit 9 (FIG. 2), wherein each of the six structural units 9 is of the same design so that only a transmitter 6, a receiver 7 and a lightguide 8, and therefore only one of the structural units 9, is described in more detail in each case below. The respective structural unit 9 is arranged along the external circumference of the external ring 2 at the same distance in each case, with the result that an angle of 45° is enclosed between two structural units 9.

Eight grooves 11, which extend in the direction of the axis of the bearing 1 and also each enclose an angle of 45° with one another, are arranged on the lateral surface of the external ring 2.

FIG. 1a shows the detail, D′ from FIG. 1 in an enlarged illustration, in a partially sectional view with respect to the apparatus 5. It is apparent that an intermediate element 16, which has a gap 17 with respect to the lightguide 8, is arranged on the base of the groove 11. The evanescent field exits from the lightguide 8 into the region of the gap 17 at the location where there is a cutout in the cladding of said lightguide 8, and said field extends as far as the intermediate element 16. A terminating element 18 adjoins, with a semicircular recess, the lightguide 8 and secures it in the intermediate element 16. Of course, the terminating element 18 can also secure the lightguide 8 directly to an outer lateral surface 15 of the external ring 2.

FIG. 3 shows that the lightguide 8 is arranged in the groove 11 on the outer lateral surface of the external ring 2, parallel with respect to an axis of the bearing 1. The lightguide 8 is arranged here in the groove 11 at a distance from the outer lateral surface 15 of the external ring 2, wherein the distance from the outer lateral surface 15 is several micrometers and is therefore not illustrated to scale in FIG. 1a. For this purpose, the lightguide 8, or the structural unit 9 which holds the latter, is attached to the external ring 2 with means which are not illustrated in more detail.

FIG. 4 shows a groove 12 which runs around the outside on the outer lateral surface 15 of the external ring 2, which, starting from the first end side 13 of the external ring 2 and ending at the second end side 14 of the external ring 2, runs around the external ring 2 by more than approximately 180° and therefore over more than approximately half the circumference of the external ring 2. The groove 12 holds here an apparatus 15 for detecting the load on the external ring 2, which apparatus also comprises a lightguide 8 (not illustrated) between a transmitter 6 and a receiver 7. The lightguide 8 encloses in this case a large angle with respect to the axis of the rolling bearing 1.

The lightguide 8 which is illustrated in FIG. 2 has, on its side facing the outer lateral surface 15 of the external ring 2, a cutout at which the cladding surrounding the lightguide 8 is omitted so that in the installation position illustrated in FIG. 1 and FIG. 3 the lightguide 8 points, with its external outer layer which has a high refractive index, at the lateral surface 15 of the external ring 2. In this region, the evanescent field exits from the lightguide 8 and fills the gap 17 between the external layer of the lightguide 8 and the outer lateral surface 15 of the external ring 2.

The transmitter 6 transmits, in particular, IR radiation, which is detected by the receiver 7. The lightguide 8 is composed of a material which is transparent to IR radiation and has a high refractive index, being composed, for example, from plastic, in particular from polycarbide or polymethylmethacrylate.

The Invention then Functions as Follows:

An evanescent field exits from the lightguide 8 at the section of the lightguide 8 at which the cladding is removed when total reflection occurs at the boundary face between the body of the lightguide 8 with respect to the gap 17, which evanescent field is formed between the lightguide 8 and the section, lying opposite the lightguide 8, of the outer lateral surface 15 of the external ring 2 in the gap 17 and extends at least partially into the region of the intermediate element 16. If mechanical loading on the bearing 1 occurs, for example when one of the rolling bodies 4 rolls over a location at which the lightguide 8 is arranged, the distance between the lightguide 8 and the lateral surface 15 of the external ring 2 or between the lightguide 8 and the intermediate element 16 changes, and the width of the gap 17 therefore changes in the radial direction. At the same time, the evanescent field is also influenced, for example as a result of the fact that diffuse scattering at the outer lateral surface 15 or incomplete reflection of the part of the evanescent field impinging on the outer lateral surface 15 causes the radiation for the lightguide 8 to be lost. Likewise, the intermediate element 16 approaches the lightguide 8, so that radiation from the lightguide 8 passes over into the intermediate element 16, but can no longer leave the intermediate element 16, so that the radiation in the intermediate element 16 is totally reflected. Overall, approximation of the lightguide 8 to the intermediate element 16 or to the outer lateral surface 15 results in a reduction in the radiation intensity which penetrates the lightguide 8. The receiver 8 detects the change in the intensity of the radiation portion transmitted through the lightguide 8 and detects in this way the mechanical load on the external ring 2.

When the lightguides 8 are arranged as in FIG. 1, in which the positions of the lightguides 8 along the circumference of the lateral surface 15 of the external ring correspond to the position of the rolling bodies 4 in the rolling bearing cage, each of the eight lightguides 8 detects maximum loading at the moment when one of the rolling bodies 4 passes the lightguide 8. A comparison circuit, which compares the measurement results of the eight lightguides 8 with one another, can then determine whether each of the rolling bodies 4 transmits a mechanical load onto the external ring 2 which is comparable in absolute value and direction. Furthermore, it is possible to determine whether the rolling bodies 4 actually pass the lightguides 8 at the same time or whether individual rolling bodies 4 have a time delay, which can indicate a damaged bearing of the respective rolling body 4 in the rolling body cage.

As an alternative to the exemplary embodiment described above, in which the lightguides 8 rest on the outer lateral surface 15 of the external ring 2 or are arranged at a distance from the outer lateral surface 15 which corresponds to the extent of the evanescent field, it may be provided that the lightguide 8 is not arranged in the groove 11 or 12 but rather bears directly on the outer lateral surface 12 or forms a gap with respect to the outer lateral surface 12. Furthermore, a groove may be formed on the inside of the internal ring 3, and alternatively to this, or in addition to this, the groove 12 on the lateral surface 15 of the external ring can hold a plurality of lightguides, or a plurality of grooves 12 may be provided, each of which grooves 12 accommodates a lightguide. Likewise, it is not absolutely necessary for the at least one lightguide to be arranged on the outer lateral surface 15, instead the at least one lightguide 8 could bear or rest on an end surface of the bearing ring or on an internal lateral surface or be held in a groove formed in the surface.

Of course, the lightguide may also be arranged in the interior of the bearing 1, for example at a distance from the raceway through which the rolling bodies 4 run.

In the exemplary embodiment described above, the evanescent field between the lightguide 8 and the intermediate element 16 is formed at the outer lateral surface 15 of the body of the external ring 2. Of course, the optical intermediate element 16 between the lightguide 8 and the surface of the bearing ring may be omitted so that the evanescent field is formed essentially between the outer or inner lateral surface of the internal ring or of the external ring and the lightguide 8.

In the exemplary embodiment described above, each of the lightguides 8 extended along the total longitudinal extent of the bearing 1 in the direction of the bearing axis of the bearing 1. Of course, the lightguide 8 forms the evanescent field only in certain sections between itself and the surface of the bearing ring. If, for example, a double-row bearing with two groups of rolling bearings is provided, a first lightguide can detect the mechanical load transmitted to the bearing ring through the first group of rolling bodies, and the same first lightguide or a second lightguide can detect the mechanical load transmitted to the bearing ring by the second group of rolling bodies.

In the exemplary embodiment described above, the lightguide 8 has a round cross section (which can be seen in FIG. 1a). Of course, the invention may also be provided for lightguides with a different cross-sectional geometry, for example for lightguides whose side which faces the outer lateral surface 12 or the intermediate element 16 has a straight profile, in particular if the side of the lateral surface 12 or of the intermediate element 16 which is pointed toward the lightguide 8 is also of planar design, so that the gap 17 is delimited by two straight parallel sides.

The invention is likewise not restricted to rolling bearings but rather relates also to other types of bearing, in particular also to sliding bearings, specifically to articulated or linear sliding bearings.

### LIST OF REFERENCE NUMERALS

1 Bearing
2 External ring
3 Internal ring
4 Rolling body
5 Apparatus for detecting the load on the bearing ring
6 Transmitter
7 Receiver
8 Optical waveguide
9 Structural unit
10 Shaft
11 Groove on external ring 2 (FIGS. 1 to 3)
12 Groove on external ring 2 (FIG. 4)
13 First end face of the external ring 2
14 Second end face of the external ring 2
15 Outer lateral surface of the external ring 2
16 Intermediate element
17 Gap
18 Terminating element

1. An apparatus for detecting a load on a bearing having at least one bearing ring, the apparatus, comprising:
a transmitter for electromagnetic radiation; and
a receiver for the electromagnetic radiation which is emitted by the transmitter,
wherein a lightguide is provided into which the transmitter inputs the electromagnetic radiation, and in that the lightguide is arranged on a surface of the at least one bearing ring, and in that the at least one bearing ring is located in a region of an evanescent field coming from the lightguide.

2. The apparatus of claim 1, wherein the lightguide extends, at least in sections, essentially parallel to an axis of the bearing.

3. The apparatus of claim 1, wherein the lightguide extends, at least in sections, at a large angle with respect to an axis of the bearing.

4. The apparatus of claim 1, wherein the lightguide is held in a groove which is formed in a surface of the at least one bearing ring.

5. The apparatus of claim 4, wherein an optical intermediate element is provided, which optical intermediate element is arranged between the surface of the at least one bearing ring and the lightguide and is covered, at least in sections, in the evanescent field coming from the lightguide.

6. The apparatus of claim 5, wherein the intermediate element is held in the groove.

7. The apparatus of claim 1, wherein the transmitter is a transmitter for IR radiation.

8. The apparatus of claim 1, wherein the lightguide is manufactured from plastic.

9. The apparatus of claim 1, wherein the surface is an external surface, in particular a lateral surface or end surface of the at least one bearing ring.

10. A bearing comprising:
at least one bearing ring, having an apparatus as claimed in claim 1, for detecting the load on the at least one bearing ring of the bearing.

11. The apparatus of claim 8, wherein the plastic used to manufacture the lightguide is polycarbide or polymethylmethacrylate.
